(19) United States
(12) Patent Application Publication
(10) Pub. No.: US 2011/0043362 A1
(43) Pub. Date: Feb. 24, 2011

(54) DEVICE FOR ENTRY DETECTION AND RECOGNITION OF TRANSPONDER BADGES, SURVEILLANCE SYSTEM COMPRISING IT, AND PROCESS FOR SURVEILLANCE IMPLEMENTED BY SAID SYSTEM

(75) Inventor: Jean-Michel REIBEL, Lampertheim (FR)

Correspondence Address: YOUNG & THOMPSON, 209 Madison Street, Suite 500, Alexandria, VA, 22314, US

(73) Assignee: RADIO SYSTEMES INGENIERIE VIDEO TECHNOLOGIES, Strasbourg (FR)

(21) Appl. No.: 12/859,881

(22) Filed: Aug. 20, 2010

(30) Foreign Application Priority Data
Aug. 20, 2009 (FR) 09 55719

(51) Int. Cl. G08B 13/00

(52) U.S. Cl. 340/541

(57) ABSTRACT

Device for detection of entry in a protected space (3′) of a residence and for recognition of transponder badges, designed to work with a central alarm unit (3) and/or anti-intrusion surveillance center of a surveillance system of the residence, and more particularly transponder badges that are present at the opening (4′) of a door (4) for access to the protected space or in the immediate vicinity of the access door, whereby the device includes a proximity reader (2) of transponder badges. The proximity reader is located inside the protected space and also integrates an independent source of electrical power supply, a set of elements for entry detection, and, optionally, elements for detection of the intention to enter, whereby the device includes, in contrast, elements that are able, during a detection of entry or of the intention to enter, to control the activation of the reader and its communication with the central unit.

This invention has as its object a device for detection of entry into a protected space of a residence and recognition of transponder badges, where said device is designed to work with a central alarm unit and/or anti-intrusion surveillance center of a surveillance system of said residence, and more particularly transponder badges that are present in the opening of a door for access to said protected space or in the immediate vicinity of said access door. It also has as its object a system for surveillance of such a residence and the surveillance process implemented by said system.

It is known that the systems for monitoring access to a protected space generally consist of a central alarm unit and/or anti-intrusion surveillance center that is connected to at least one keyboard reader, located at the door for access to said protected space, making it possible to capture a personal identification code designed to be verified by said central unit.

When the identification signal is not recognized by the central alarm unit and/or anti-intrusion surveillance center, the latter then generates an alarm procedure, generally consisting in triggering an audible alarm and/or an intervention procedure, generally consisting of an intervention of remote audible monitoring from the surveillance center or an on-site security intervention.

Other surveillance systems are also known that prevent the user from entering a code using a keyboard with keys of the reader by inserting an individual badge that contains an identification code in a slot that is especially provided in the reader or by presenting a badge without contact or a transponder badge in proximity to the reader.

The latter, commonly called a proximity reader, is then designed to communicate with the transponder badge by radio-frequency and to transmit an interrogation signal in the direction of said transponder badge, located in its radiation field at a suitable distance, to the transponder badge, after having received said interrogation signal, transmitting in response an identification signal bound for said proximity reader.

The proximity reader later transmits the identification signal to the central alarm unit and/or anti-intrusion surveillance center that generates an alarm and/or intervention procedure if said identification signal is not verified and validated by said central unit.

The transponder badges generally comprise, on the one hand, an electronic chip that consists of a memory unit and a microprocessor that is able to process information and to ensure security levels, and, on the other hand, an antenna for transmitting/receiving radio-frequency signals connected to said electronic chip.

Among the different types of transponder badges, active transponder badges are known that have their own supply of electrical power, and passive transponder badges are known that have a lower cost than said active transponder badges that do not comprise their own power supply but that are remotely fed by power transmitted by the proximity reader, inducing current in the electrical circuits of the passive transponder badge.

Such a remote reading technology of a transponder badge is well known under the technological name RFID, abbreviation of the English term “Radio-Frequency Identification.”

However, these readers require significant energy or power to obtain an effective coverage zone of the proximity reader. Actually, the proximity reader is to be activated permanently or periodically to be in operation when a transponder badge is in proximity, in its emission field, with a shorter or longer reaction time according to the application. The proximity reader should therefore be connected to a permanent and consistent energy source, in particular of the sector type.

Actually, the problem of the energy consumption of the proximity reader is posed more particularly with passive transponder badges that require from the latter very significant emission energy to make it possible for said transponder badges to pick up a negligible portion thereof for their operation.

Furthermore, the yield is very low since, for example, for power dissipated in the proximity reader on the order of 500 mW, the transponder badge recovers less than 1% of it, with a coverage distance, i.e., the distance of communication between said proximity reader and a transponder badge, of approximately several centimeters.

Relative to the active badges used for the identification of individuals, of which the on-board energy is used to feed the circuits of said badges and to amplify the signals coming from the proximity reader, the distance of coverage of the latter is more significant than with the passive transponder badges but remains limited to several meters, in general from 1 to 3 m.

In addition, the energy consumption of the proximity reader is not restricted to its exchanges with transponder badges but can also result from different communications between said proximity reader and the central alarm unit and/or surveillance center.

The electrical power consumption of the proximity reader is therefore a crucial problem when the latter is to be made independent, with its own energy source, so as to avoid any electrical wiring of the proximity reader, in particular with an external supply of the sector type, and to enable an easy installation of said proximity reader at strategic locations, in particular at a door for access to a space that is protected under alarm and/or anti-intrusion surveillance or in the immediate vicinity of the latter.

The object of this invention is to eliminate these drawbacks by proposing a device for detection of entry into a protected space 3′ of a residence and recognition of transponder badges that work with a central alarm unit and/or anti-intrusion surveillance center of a surveillance system of said residence, having a great compactness and being adapted to be easily installed in an independent manner in a door for access to the protected space or in proximity to the latter, with a low consumption of electrical power.

For this purpose, the device for detection of entry, according to this invention, in a protected space of a residence and for recognition of transponder badges, is designed to work with a central alarm unit and/or anti-intrusion surveillance center of a surveillance system of said residence, and more particularly transponder badges that are present at the opening of a door for access to said protected space or in the immediate vicinity of said access door, whereby said device comprises a proximity reader of said transponder badges and is characterized essentially in that, on the one hand, said proximity reader is located in the protected space, preferably near, more preferably in the immediate vicinity of, the opening of said access door and also integrates an independent source of electrical power supply, a set of means for detection of entry into the protected space comprising means for detection of the opening of said access door and/or means for detection of the passage of a subject or user crossing the threshold of the access door, and, optionally means for detection of the intention to enter of a subject or user indicating his intention of passing through said door, and, on the other hand, in that it comprises means that are able, during a detection of entry, or, if necessary, a detection of the intention to enter, to automatically control the activation of said proximity reader and the communication of the latter with the central alarm unit and/or anti-intrusion surveillance center of said surveillance system and with a transponder badge that is present for the purpose of establishing a transfer of data within the framework of a procedure for identification and recognition of the transponder badge in question, and then, if no authorized badge is recognized and an entry detection is effective, an alarm and/or intervention procedure by said central unit.

This invention also has the object of proposing a system for surveillance of a residence that comprises a central alarm unit and/or anti-intrusion surveillance center, essentially being characterized in that said central unit works with at least one device for detection of entry in a protected space of said residence and recognition of transponder badges, according to this invention, and with means for detection of a presence in said residence that are designed to be activated, in an arming mode of said central unit, for detection of the presence of individuals located inside said protected space and optionally with means for perimetric detection that are designed to be activated in at least point arming mode of said central unit for detection of the presence of individuals at exits emerging on the outside of said residence and associated with an entry timer enabling said device to be allowed the necessary time so that the reading and validation of the badge can take place.

This invention also has as its object to propose a process for surveillance of a residence that is implemented by the surveillance system according to this invention that is characterized essentially in that it consists in:
Activating, following detection of an entry, or, optionally, detection of the intention to enter the protected space, using entry detection means or, optionally, means for detection of the intention to enter integrated in the proximity reader of the device for entry detection and recognition according to this invention, a protocol for recognition of transponder badges, comprising stages for communication between a transponder badge, the proximity reader, and said central alarm unit and/or anti-intrusion surveillance center, said central unit then being able, following said communication stages:
Either to ignore said detections of entry by being put into point disarming mode, i.e., in the mode to authorize presence in said protected space and point inhibition of the alarm and/or intervention procedure, if said identified transponder badge is recognized by said central unit or said reader,
Or to generate an alarm and/or intervention procedure if a detection of entry in the protected space from the access door is effective and if said identified transponder badge is not recognized by said central unit or said reader, or, if necessary, when said central unit is put into point disarming mode, if an individual is nevertheless detected by the perimetric presence detection means and then kept in activation mode;
If necessary, to initiate the entry timer following a perimetric presence detection so as to allow a necessary period for the execution of said stages for communication of the recognition protocol of the badge in question.

The invention will be better understood using the description below, which relates to a preferred embodiment, provided by way of nonlimiting example and explained with reference to the accompanying diagrammatic drawings, in which:

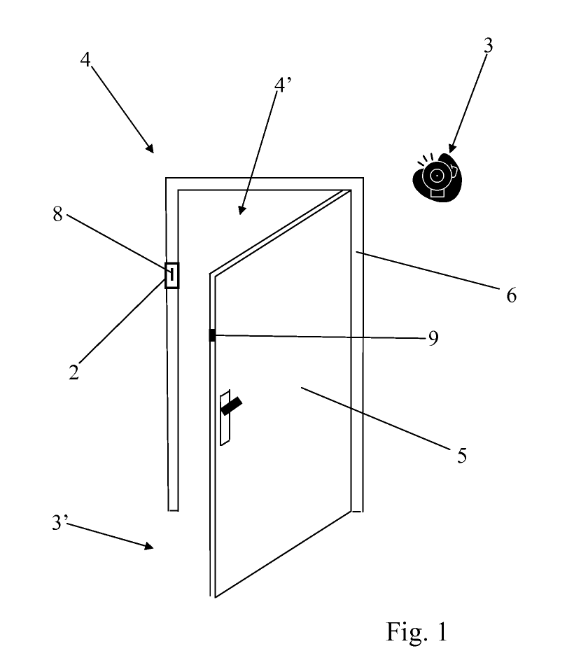

FIG. 1 shows a device for entry detection and recognition, according to this invention, installed on a door for access to a protected space, in a first embodiment of the means for the detection of the opening of said access door,

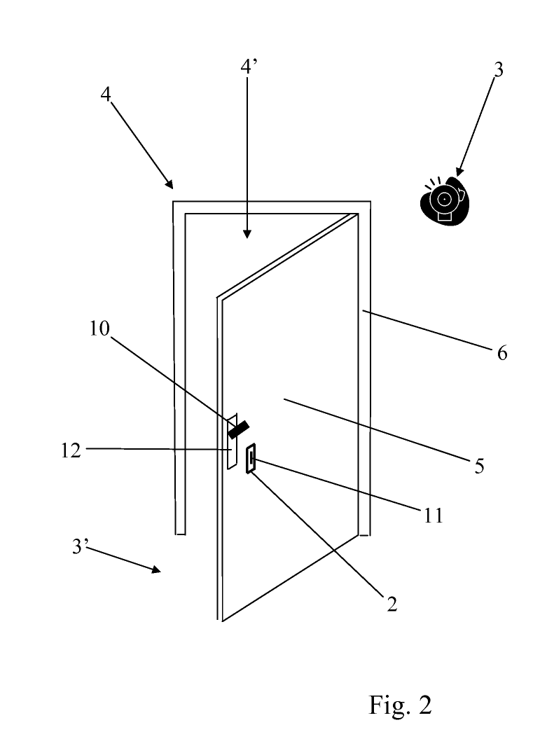

FIG. 2 shows a device for entry detection and recognition, according to this invention, installed on a door for access to a protected space, in a first embodiment of the passage detection means,

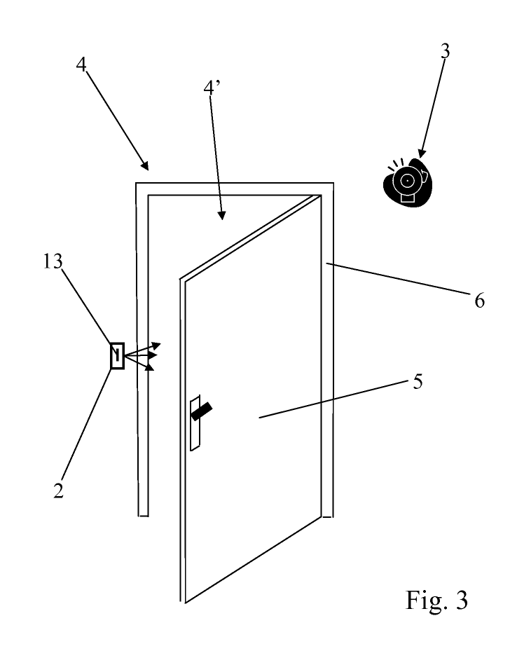

FIG. 3 shows a device for entry detection and recognition, according to this invention, installed on a door for access to a protected space, in a second embodiment of the passage detection means,

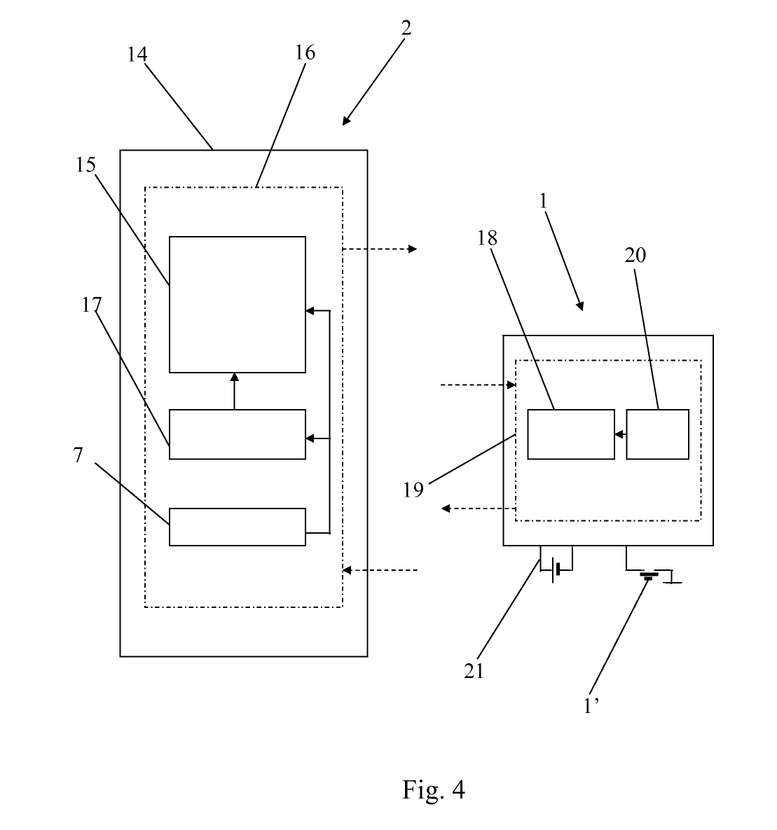

FIG. 4 shows the functional schema of a device according to this invention,

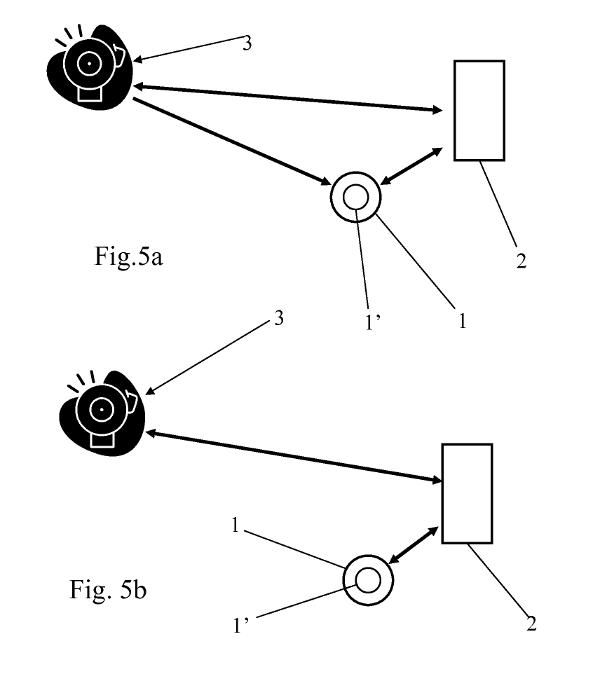

FIG. 5a is a diagrammatic representation of the device according to this invention, in communication position with a central alarm unit and/or an anti-intrusion surveillance center, in a first embodiment of the surveillance process,

FIG. 5b is a diagrammatic representation of the device according to this invention, in a communication position with a central alarm unit and/or anti-intrusion surveillance center, in a second embodiment of the surveillance process.

The figures show a device for entry detection and recognition of transponder badges 1 according to this invention, designed to work with a central alarm unit 3 and/or anti-intrusion surveillance center of a system for monitoring access in a protected space 3′, and more particularly transponder badges 1 that are present at the opening 4′ of a door 4 for access to said protected space 3′ or in the immediate vicinity of said opening 4′, whereby said access door 4 consists of at least one leaf 5, whereby said device comprises a proximity reader 2 of said transponder badges 1.

According to this invention, the proximity reader 2 is located in the protected space 3′, preferably near, more preferably in the immediate vicinity of, the opening 4′ of said access door 4 (FIG. 1 and FIG. 3) and also integrates an independent source of electrical power supply 7, a set of means 8, 9; 13 for detection of entry into the protected space 3′ comprising means 8, 9 for detection of the opening of said access door 4 and/or means 13 for detection of the passage of a subject or user crossing the threshold of the access door 4, and, optionally, means 10, 11 for detection of the intention to enter of a subject or user indicating his intention of passing through said door 4.

In contrast, the device according to this invention comprises means that are able, during a detection of entry, or, if necessary, a detection of the intention to enter, to automatically control the activation of said proximity reader 2 and the communication of the latter with the central alarm unit 3 and/or anti-intrusion surveillance center of the surveillance system and with a transponder badge 1 that is present for the purpose of establishing a transfer of data within the framework of a procedure for identification and recognition of the transponder badge 1 in question, and then, if no authorized badge 1 is recognized and an entry detection is effective, an alarm and/or intervention procedure by the central alarm unit 3.

Preferably, the device according to this invention can also comprise a control means 1′ that makes it possible for the user to activate the surveillance system, in particular by leaving the protected space 3′. Such a control means can consist of, for example, at least one push button 1′ that is preferably located on the proximity reader 2 that is itself preferably attached near the access door 4 or on a transponder badge 1 that makes it possible to use the latter in some way as a “classical” radio remote control (FIG. 4, FIG. 5a and FIG. 5b) or else as a switch, not shown, preferably placed in the vicinity of said proximity reader 2.

In one particular embodiment, the proximity reader 2 can advantageously be able to verify the presence of a transponder badge 1 at the time when the user is able to press said badge on the push button 1′ to activate the surveillance system while leaving the protected space 3′, so as to avoid forgetting said badge 1 by mistake. Furthermore, a specific signal, for example an audible signal, can indicate this oversight to the user, who can optionally still activate said surveillance system by again pressing the push button 1′.

It will be noted that the command that makes it possible to activate the surveillance system can advantageously be subject to the detection of the opening of the access door 4 or to the detection of passage. Taking into account the command can also be subject to the presence of a transponder badge 1, depending on whether or not it is desired to keep just anyone from arming the surveillance system and in particular the central unit 3 or to allow only an individual who possesses said transponder badge 1 to do so. Several command means can make it possible to allow the selection of the activation mode such as, for example, partial, total or else perimetric.

Passage detection means will be defined as detection means that make it possible to detect, in particular, the passage of an individual through the opening 4′ of the access door 4 and in particular an individual who crosses the threshold or the gap of said access door 4 and enters into the protected space 3′ and by means of detection of the intention to enter of the detection means making it possible to detect the presence of an individual indicating his unambiguous intention to open the access door 4, i.e., being in a position to actuate the opening 4′ of said access door 4 or in a position to express the intention of passing through said opening 4′ to penetrate the protected space 3′.

According to this invention, at least one portion of the identification data can be transferred from the proximity reader 2 to the central alarm unit 3 and/or the anti-intrusion surveillance center, using radio-frequency communication means 16 of said proximity reader 2.

In one variant, each transponder badge 1 can comprise radio-frequency communication means 20 with the central alarm unit 3 and/or anti-intrusion surveillance center, and at least one portion of the identification data can be transferred from said transponder badge 1 to said central unit 3.

If reference is made to FIG. 1, it is possible to see that, in a first embodiment of the means for detection of the opening of the access door 4, the proximity reader 2 can be attached, inside the protected space 3′, either to the casing 6, in particular the casing frame, of said access door 4 or in the immediate vicinity of the latter, or on the leaf 5 of said access door 4, whereby said means for detecting the opening of the access door 4 consist of a proximity sensor that consists essentially of a set of two components 8 and 9, which work together, namely an element 9 that transmits a permanent external magnetic field, for example a magnet, and a magnetic detector 8, for example an ILS sensor, able to detect said element 8. One of said components 8 and 9 is advantageously integrated in said proximity reader 2 while the other is either mounted in or on the casing 6 or in the immediate vicinity of the latter when said proximity reader 2 is attached to the leaf 5, or mounted in or on the leaf 5, when said proximity reader is attached to the casing 6 or in the immediate vicinity of the latter.

If reference is now made to FIG. 2, it is possible to see that in one preferred embodiment of means for detection of an intention to enter, the proximity reader 2 can be attached to the leaf 5 of the access door 4, mounted to pivot in the protected space 3′, which comprises an opening element 10, in particular from the outside of the protected space 3′, for example a handle, whereby said detection means consist of a touch sensor 11, connected to or integrated in said opening element 10 and making it possible to detect the contact of a subject or a user with the latter.

The proximity reader 2 can be attached in the immediate vicinity of the clean plate 12 for the locking of the access door 4 or can be integrated in said plate 12. In addition, the touch sensor can preferably be a capacitive sensor 11 that can measure the capacitance of the electrode that advantageously can be formed by the opening element 10 that comes more particularly in the form of a door handle, this more particularly by electrically connecting the shaft, not shown, of said handle 10 to the input of the capacitive detection of said sensor 11.

FIG. 3 shows that in one preferred embodiment of passage detection means, the latter can consist of a motion detector 13, placed in the protected space 3, for example sensitive to passive infrared rays, oriented so as to be activated by the movement of a subject or a user who passes through the opening 4′of the access door 4 in the direction of the protected space 3′ and more particularly during his passage over the threshold or into the gap of said access door 4.

More particularly, in this second embodiment, the line of sight of the motion detector 13 will be oriented in the protected space 3′ for a more effective result, perpendicular to the direction of movement of an individual who enters into the protected space 3′ by passing through the opening 4′ of the access door 4.

In another embodiment of the means for detecting the opening of the access door, the latter can consist of an accelerometer-type sensor that makes it possible to detect the opening 4′ of the access door 4 by measuring in particular the displacement velocity of the leaf 5 of said access door 4.

Other sensors could also be used without thereby leaving the scope of this invention such as optical motion sensors.

Thus, a proximity reader 2 of the device according to this invention, in addition to its reading function of transponder badges 1 located in the perimeter of the access door 4 and in particular at the level of or in the immediate proximity of its opening 4′, also ensures, according to the type of the detection means and according to the embodiment of the proximity reader 2 on the access door 4 or in the vicinity of the latter, the detection function:
Either of the passage of a subject or a user who passes through the opening 4′ of the access door 4 to go into the protected space 3′ and more particularly an individual who crosses the threshold or the gap of said access door 4 (FIG. 3) or the presence of an individual in a position to actuate the opening of said access door 4 from the outside of the protected space 3′ or to express his unambiguous intention to pass through said opening 4′ (FIG. 2),
Or an opening of the leaf 5 of said access door 4 that indicates the possible presence of an individual who is ready to cross or that crosses the opening 4′ of said door 4, and in particular the threshold or the gap of said access door 4 to the inside of the protected space 3′ (FIG. 1).

It will be noted that a leaf 5 can have several shapes and can be, for example, of the flap or revolving-door type.

In contrast, the proximity reader 2 can advantageously comprise at least one sensory restoration means, not shown, designed to warn a user, located in the protected space 3′, of the absence of a transponder badge 1 and/or the presence of a transponder badge 1 that is not recognized by the central alarm unit 3 and/or anti-intrusion surveillance center when the access door 4 is opened or upon contact of said user with an opening element 10 of this door 4.

If reference is now made to FIG. 4, it is possible to see that a proximity reader 2 can comprise essentially a protective case 14 that contains a microprocessor 15, a radio-frequency transmitting/receiving antenna 16, a module for detecting the passage and/or opening of door 17, and an independent electrical power supply source 7.

Preferably, the protective case 14 can contain capacitive detection means, not shown, able to point out an act of sabotage on said proximity reader 2, whereby said detecting means can consist of one or more electrodes that are connected to a capacitive detection circuit and placed at suitable locations on said protective case 14 and/or inside the latter.

In addition, the proximity reader 2 advantageously can have a reduced shape factor, i.e., reduced dimensions and a shape that make it possible for it to be attached in particular inside the protected space 3′ in an appropriate manner on the casing 6, in particular the casing frame, of the access door 4 (FIG. 1).

It is also possible to see in FIG. 4 that a transponder badge 1 can comprise essentially a microprocessor 18, a radio-frequency transmitting/receiving antenna 19, and, in particular in the case of a passive transponder badge 1, a field presence alarm module 20.

In one example of the operation of the device according to this invention, the proximity reader 2 will send an interrogation signal using the radio-frequency transmitting/receiving antenna 16 to the transponder badge 1 that will receive it using its radio-frequency transmitting/receiving antenna 19 if the latter is located close enough to said proximity reader 2, i.e., at the level of the access door 4 or in the immediate vicinity of the latter, then said transponder badge 1, acted upon or activated by said interrogation signal, will in return transmit—using its transmitting/receiving antenna 19—an identification signal that comprises an identifier combined with an authenticator to the proximity reader 2 (FIG. 5a and FIG. 5b).

A transponder badge 1 can be either an active badge that bears its own electrical power source 21 (FIG. 4) and that can transmit in a cyclic manner an identification signal that is designed to be received by the proximity reader 2, or a passive badge that depends entirely on the power transmitted by the proximity reader 2 and that therefore does not comprise any power source.

This invention also has as its object a system for surveillance of a residence that comprises a central alarm unit 3 and/or anti-intrusion surveillance center.

According to this invention, said central unit 3 works with at least one device for detection of entry into a protected space 3′ of said residence and for recognition of transponder badges 1, according to this invention, and with means for detection of a presence in said residence that are designed to be activated, in the arming mode of said central unit, to detect the presence of individuals located inside said protected space 3′ and, optionally, with perimetric detection means designed to be activated, in at least point arming mode of said central unit, to detect the presence of individuals at exits emerging on the outside of said residence and associated with an entry timer enabling said device to be allowed the necessary time so that the reading and the validation of the badge can take place.

Such a perimetric protective device for the exits that emerge on the outside of the residence can comprise, in a known manner, for example, hyperfrequency detection systems that make it possible to detect movement in a given volume or infrared barrier systems that make it possible to detect a passage at a given site or else embedded volumetric detection means that are able to detect an individual who moves into the perimeter that is under surveillance.

This type of perimetric protection is therefore to be distinguished from protections that comprise detectors for motion or presence located inside the protected volume and enables individuals who are present in the protected space 3′ to circulate freely in the latter while ensuring its perimetric protection against possible intruders.

Thus, the entry detection device according to this invention makes possible a transparent access into the protected space for the user, without hindering the entry.

This invention also has the object of a process for surveillance of a residence that is used by the system as described above.

According to this invention, it consists in:
Activating, following a detection of entry, or, optionally, a detection of the intention to enter the protected space 3′, using entry detection means 8, 9; 13, or, optionally, with means 10, 11 for detection of the intention to enter integrated in the proximity reader 2 of the device for entry detection and recognition according to this invention, a protocol for recognition of transponder badges 1, comprising stages for communication between a transponder badge 1, the proximity reader 2 and said central alarm unit 3 and/or anti-intrusion surveillance center,
   said central unit 3 then being able, following said communication stages:
Either to ignore said detections of opening or passage by being put into at least point disarming mode, i.e., in the mode to authorize presence in said protected space 3′ and point inhibition of the alarm and/or intervention procedure, if said transponder badge 1 that is identified is recognized by said central unit 3 or said reader 2,
Or to generate an alarm and/or intervention procedure, if a detection of entry, in the protected space 3′ from the access door 4, is effective and if said identified transponder badge 1 is not recognized by said central unit 3 or said reader 2 or, if necessary, when said central unit 3 is put into point disarming mode if an individual is detected by the means for detection of perimetric presence then maintained in activation mode;
If necessary, to initiate the entry timer following a perimetric presence detection so as to allow a necessary period for the execution of said stages for communication of the recognition protocol of the badge in question.

In the case where the surveillance system according to this invention comprises perimetric protection means as mentioned above, it will then be understood that the process according to this invention can lead, not to a complete disarming of the central alarm unit 3, but to keeping the perimetric means in activation mode, such that the entry of an individual into the residence in question with an identified and authenticated transponder badge 1 will cause only a point neutralization, i.e., a neutralization of the means for detection of opening and means for detection of passage. In this manner, it is not necessary for said individual to reactivate the perimetric detection means.

If reference is now made to FIG. 5a, it can be seen that in a first embodiment of the surveillance process according to this invention, the communication stages essentially comprise the following successive stages:
The proximity reader 2, following an entry detection or, optionally, a detection of the intention to enter, transmits an activation or alarm signal to a transponder badge 1 that is located in its field of emission at a suitable distance,
The transponder badge 1 receives the activation or alarm signal and in return transmits to the proximity reader 2 an identification signal that comprises an identifier associated with an authenticator,
The proximity reader 2 sends said identification signal to the central alarm unit 3 and/or anti-intrusion surveillance center that uses the list of authorized transponder badges 1 making it possible to recognize said badge or not,
The central alarm unit 3 and/or the anti-intrusion surveillance center then sends a release to the transponder badge 1 and an information signal for validation or invalidation to the proximity reader, and then
Either the central unit 3 is put in disarming mode, if necessary in a point manner, if the authenticator is recognized by said central unit 3,
Or the central unit 3 generates an alarm and/or intervention procedure if a detecting of entry, in the protected space 3′ from the access door 4, is effective and if the authenticator is not recognized by said central unit 3, or, if necessary, when said central unit 3 is put into point disarming mode, if an individual is detected by the perimetric protection means.

FIG. 5b shows that in a second embodiment of the surveillance process according to this invention, the stages of communication can comprise essentially the following successive stages:
The proximity reader 2, following a detection of entry or, optionally, a detection of an intention to enter, transmits an activation or alarm signal to a transponder badge 1 that is located in its field of emission at a suitable distance, and, simultaneously, the proximity reader 2 activates the reception of the response channel of the transponder badge 1 either continuously or alternately if the activation signal uses the same channel,
The transponder badge 1 receives the activation or alarm signal and in return transmits an identification signal that comprises an identifier that is combined with an authenticator bound to the proximity reader 2 that uses the list of valid badges, previously loaded in said reader, making it possible to recognize said badge or not,
The proximity reader 2 verifies the identification signal that is received from said badge and sends a message to the central unit 3 to inform it of the result of said verification,
The central alarm unit 3 and/or surveillance center transmits a release to the proximity reader 2, and then
Either the central unit 3 is put into disarming mode, if necessary in a point manner, if the authenticator is recognized by said reader 2,
Or the central unit 3 generates an alarm and/or intervention procedure if an entry detection, in the protected space 3′ from the access door 4, is effective and if the authenticator is not recognized by said reader 2, or, if necessary, when said central unit 3 is put into point disarming mode, if an individual is detected by the perimetric protection means.

It will be understood that in this second embodiment of the communication protocol, the transponder 1 does not communicate directly with the central alarm unit 3 and/or the anti-intrusion surveillance center but only with the proximity reader 2. Thus, the emission power can be reduced very significantly, and the radio channel can be selected independently from the rest of the system.

A variant of this second embodiment can consist in, at the level of the transponder badge 1, replacing the cyclic reception by a cyclic transmission. Within this framework, to obtain adequate security, the transmission should comprise authentication data, combined with the identifier of the transponder (unique code), as well as evolving data, such as, for example, a meter or the date and hour, designed to prevent the replays of radio sequences. The proximity reader 2 will activate in particular the appropriate reception with the transponder badge 1, following a passage detection by said proximity reader 2.

Preferably, to economize the energy consumed by the proximity reader 2, the latter advantageously will be activated to be put into an active reading mode of the transponder badges 1 following a detection of the opening or passage and will advantageously be maintained in said activation mode for a predetermined period, for example using a timer, as long as no valid transponder badge 1 is detected by said reader 2.

In addition, still for the purpose of saving energy in the case where an active transponder badge 1 activates its means for detection of the activation signal coming from the proximity reader 2 periodically, the transmission period of said activation signal, on the part of the proximity reader 2, will advantageously be longer than the detection period on the part of the transponder badge.

Of course, the invention is not limited to the embodiment described and shown in the accompanying drawings. Modifications remain possible, in particular from the standpoint of the composition of various elements or by substitution of equivalent techniques, without thereby exceeding the field of protection of the invention.

1. Device for detection of entry in a protected space (3′) of a residence and for recognition of transponder badges (1), designed to work with a central alarm unit (3) and/or anti-intrusion surveillance center of a surveillance system of said residence, and more particularly transponder badges (1) that are present at the opening (4′) of a door (4) for access to said protected space (3′) or in the immediate vicinity of said access door (4), whereby said device comprises a proximity reader (2) of said transponder badges (1),
device that is characterized in that, on the one hand, said proximity reader (2) is located in the protected space (3′), preferably near, more preferably in the immediate vicinity, of the opening (4′) of said access door (4) and also integrates an independent source of electrical power supply (7), a set of means (8, 9; 13) for detection of entry in the protected space (3′) comprising means (8, 9) for detecting the opening of said access door (4) and/or means (13) for detection of the passage of a subject or user crossing the threshold of the access door (4), and, optionally, means (10, 11) for detection of the intention to enter of a subject or user indicating his intention of passing through said door (4), and, on the other hand, in that it comprises means that are able, during a detection of entry, or, if necessary, a detection of the intention to enter, to automatically control the activation of said proximity reader (2) and the communication of the latter with the central alarm unit (3) and/or anti-intrusion surveillance center of the surveillance system and with a transponder badge (1) that is present for the purpose of establishing a data transfer within the framework of a procedure for identification and recognition of the transponder badge (1) in question, and then, if no authorized badge (1) is recognized and an entry detection is effective, an alarm and/or intervention procedure by said central unit (3).

2. Device according to claim 1, wherein it also comprises a control means (1′) that makes it possible for the user leaving the protected space (3′) to activate the surveillance system, whereby said control means comes, for example, in the form of at least one push button (1′) that is located on the proximity reader (2).

3. Device according to claim 1, wherein the proximity reader (2) is attached, either to the casing (6) of the access door (4) or in the immediate vicinity of the latter, or on the leaf (5) of said access door (4), and wherein the means for detection of the opening of the access door (4) consist of a proximity sensor that consists essentially of a set of two components (8 and 9), which work together, namely an element (9) that transmits a permanent external magnetic field, for example a magnet, and a magnetic detector (8), for example an ILS sensor, able to detect said element (8), and wherein one of said components (8 and 9) is integrated in said proximity reader (2) while the other is either mounted in or on the casing (6) or in the immediate vicinity of the latter, when said proximity reader (2) is attached to the leaf (5), or mounted in or on the leaf (5), when said proximity reader is attached to the casing (6) or in the immediate vicinity of the latter.

4. Device according to claim 1, wherein the proximity reader (2) is attached to the leaf (5) of the access door (4), which comprises an opening element (10), for example a handle, and wherein the means for detection of the passage consist of a touch sensor (11), connected to or integrated in said opening element (10) and making it possible to detect the contact of a subject or user with the latter.

5. Device according to claim 4, wherein the proximity reader (2) is attached in the immediate vicinity of the clean plate (12) for the locking of the door (4) or is integrated in said plate (12) and wherein the touch sensor is a capacitive sensor (11) that can measure the capacitance of the electrode that is formed by the opening element (10) and more particularly, when said opening element (10) comes more particularly in the form of a door handle, by electrically connecting the shaft of said handle (10) to the input of the capacitive detection of said capacitive sensor (11).

6. Device according to claim 1, wherein the passage detection means consist of a motion detector (13) that is, for example, sensitive to passive infrared rays and oriented so as to be activated by the movement of a subject or a user who passes through and/or is directed toward the opening (4′) of the access door (4), in particular in the direction of the protected space (3′).

7. Device according to claim 1, wherein the means for detection of the opening of the access door (4) consist of an accelerometer-type sensor that makes it possible to detect the opening (4′) of the access door (4) by measuring the displacement velocity of the leaf (5) of said access door (4).

8. Device according to claim 1, wherein the proximity reader (2) also comprises at least one means for sensory restoration that is designed to warn a user, located in the protected space (3′), of the absence of a transponder badge (1) and/or of the presence of a transponder badge (1) that is not recognized by the central alarm unit (3) and/or anti-intrusion surveillance center during the opening (4′) of the access door (4) or the contact of said user with an opening element (10) of this door (4).

9. Device according to claim 1, wherein the proximity reader (2) is mounted in a protective case (14) that contains capacitive detection means that can indicate an act of sabotage on said proximity reader (2), whereby said detection means consist of one or more electrodes that are connected to a capacitive detection circuit and placed at appropriate locations on said protective case (14) and/or inside the latter.

10. Device, according to claim 1, wherein the proximity reader (2) has a reduced shape factor.

11. System for surveillance of a residence comprising a central alarm unit (3) and/or an anti-intrusion surveillance center, wherein said central unit (3) works with at least one device for detection of entry in a protected space (3′) of said residence and recognition of transponder badges (1), according to claim 1, and with means for detection of a presence in said residence that are designed to be activated, in an arming mode of said central unit, for detection of the presence of individuals located inside said protected space 3′, and, optionally, with means for perimetric detection that are designed to be activated in at least point arming mode of said central unit, for detection of the presence of individuals at exits emerging on the outside of said residence and associated with an entry timer enabling said device to be allowed the necessary time so that the reading and validation of the badge can take place.

12. Process for surveillance of a residence implemented by the system according to claim 11, wherein it consists in:
Activating, following detection of an entry, or, optionally, detection of the intention to enter into the protected space (3′), using entry detection means (8, 9; 13) or, optionally, means (10, 11) for detection of the intention to enter integrated in the proximity reader (2) of the device for entry detection and recognition, a protocol for recognition of transponder badges (1), comprising stages for communication between a transponder badge (1), the proximity reader (2), and said central alarm unit (3) and/or anti-intrusion surveillance center, said central unit (3) then being able, following said communication stages:
Either to ignore said detections of entry by being put into point disarming mode, i.e., in the mode to authorize presence in said protected space (3′) and point inhibition of the alarm and/or intervention procedure, if said identified transponder badge (1) is recognized by said central unit (3) or said reader (2),
Or to generate an alarm and/or intervention procedure, if a detection of entry, in the protected space (3′) from the access door (4), is effective and if said identified transponder badge (1) is not recognized by said central unit (3) or said reader (2), or, if necessary, when said central unit (3) is put into point disarming mode, if an individual is nevertheless detected by the perimetric presence detection means then kept in activation mode;
If necessary, to initiate the entry timer following a perimetric presence detection so as to allow a necessary period for the execution of said stages for communication of the recognition protocol of the badge in question.

13. Process of surveillance, according to claim 12, wherein the communication stages essentially comprise the following successive stages:
The proximity reader (2), following an entry detection or, optionally, a detection of the intention to enter, transmits an activation or alarm signal to a transponder badge (1) that is located in its field of emission at a suitable distance,
The transponder badge (1) receives the activation or alarm signal and in return transmits to the proximity reader (2) an identification signal that comprises an identifier associated with an authenticator,
The proximity reader (2) sends said identification signal to the central alarm unit (3) and/or anti-intrusion surveillance center that uses the list of authorized transponder badges (1) making it possible to recognize said badge or not,
The central alarm unit (3) and/or the anti-intrusion surveillance center then send(s) a release to the transponder badge (1) and an information signal for validation or invalidation to the proximity reader (2), and then
Either the central unit (3) is put in disarming mode, if necessary in a point manner, if the authenticator is recognized by said central unit (3),
Or the central unit (3) generates an alarm and/or intervention procedure if a detection of entry, in the protected space (3′) from the access door (4), is effective and if the authenticator is not recognized by said central unit (3), or, if necessary, when said central unit (3) is put into point disarming mode, if an individual is detected by the perimetric protection means.

14. Process of surveillance, according to claim 12, wherein the communication stages essentially comprise the following successive stages:
The proximity reader (2), following an entry detection or, optionally, a detection of the intention to enter, transmits an activation or alarm signal to a transponder badge (1) that is located in its field of emission at a suitable distance, and, simultaneously, the proximity reader (2) activates the reception of the response channel of the transponder badge (1) either continuously or alternately if the activation signal uses the same channel,
The transponder badge (1) receives the activation or alarm signal and in return transmits an identification signal that comprises an identifier associated with an authenticator bound for the proximity reader (2) that uses the list of valid badges, previously loaded into said reader, making it possible to recognize said badge or not,
The proximity reader (2) verifies the identification signal that is received from said badge and sends a message to the central unit (3) to inform it of the result of said verification,
The central alarm unit (3) and/or surveillance center transmits a release to the proximity reader (2), and then
Either the central unit (3) is put into disarming mode, if necessary in a point manner, if the authenticator is recognized by said reader (2),
Or the central unit (3) generates an alarm and/or intervention procedure if an entry detection is effective and if the authenticator is not recognized by said reader (2), or, if necessary, when said central unit (3) is put into point disarming mode, if an individual is detected by the perimetric protection means.

15. Process, according to claim 13, wherein the proximity reader (2) is activated to be put into an active reading mode of the transponder badges (1) following an entry detection and wherein it is maintained in said activation mode for a predetermined period, until no valid transponder badge (1) is detected by said reader (2).

16. Device according to claim 2, wherein the proximity reader (2) is attached, either to the casing (6) of the access door (4) or in the immediate vicinity of the latter, or on the leaf (5) of said access door (4), and wherein the means for detection of the opening of the access door (4) consist of a proximity sensor that consists essentially of a set of two components (8 and 9), which work together, namely an element (9) that transmits a permanent external magnetic field, for example a magnet, and a magnetic detector (8), for example an ILS sensor, able to detect said element (8), and wherein one of said components (8 and 9) is integrated in said proximity reader (2) while the other is either mounted in or on the casing (6) or in the immediate vicinity of the latter, when said proximity reader (2) is attached to the leaf (5), or mounted in or on the leaf (5), when said proximity reader is attached to the casing (6) or in the immediate vicinity of the latter.

17. Device according to claim 2, wherein the proximity reader (2) is attached to the leaf (5) of the access door (4), which comprises an opening element (10), for example a handle, and wherein the means for detection of the passage consist of a touch sensor (11), connected to or integrated in said opening element (10) and making it possible to detect the contact of a subject or user with the latter.)

18. Process, according to claim 14, wherein the proximity reader (2) is activated to be put into an active reading mode of the transponder badges (1) following an entry detection and wherein it is maintained in said activation mode for a predetermined period, until no valid transponder badge (1) is detected by said reader (2).
